(19) United States
(12) Patent Application Publication
(10) Pub. No.: US 2011/0106765 A1
(43) Pub. Date: May 5, 2011

(54) BACKUP DEVICE AND CONTROL DEVICE FOR BACK UP

(75) Inventor: Yutaka Yoshida, Matsumoto-shi (JP)

(73) Assignee: Seiko Epson Corporation, Tokyo (JP)

(21) Appl. No.: 12/916,801

(22) Filed: Nov. 1, 2010

(30) Foreign Application Priority Data
Nov. 2, 2009 (JP) 2009-252185

(51) Int. Cl. G06F 17/30

(52) U.S. Cl. 707/640; 707/E17.007

(57) ABSTRACT

A backup device which backs up data in a predetermined medium includes a first data acquisition element that acquires backup data, a second data acquisition element that acquires recorded data which has been already recorded in the predetermined medium, and a backup processing element that judges whether the backup data matches with the recorded data, records the backup data and reference data for referring to the backup data in the predetermined medium when the backup processing element judges that the backup data does not match with the recorded data, and records reference data of which reference destination is set to the recorded data which matches with the backup data in the predetermined medium when the backup processing element judges that the backup data matches with the recorded data.

### CROSS REFERENCES TO RELATED APPLICATIONS

The present invention contains subject matter related to Japanese Patent Application No. 2009-252185 filed in the Japanese Patent Office on Nov. 2, 2009, the entire contents of which are incorporated herein by reference.

### BACKGROUND

1. Technical Field

The present invention relates to a backup device and a control device for backup.

2. Related Art

As an existing backup device of this type, a backup device which sequentially reads out files to be backed up from a disk drive by a directory search processing and transfers the read-out files to a backup destination has been proposed (for example, JP-A-2009-145967).

When backup of data is periodically repeated by using such a backup device, the same data is redundantly recorded in some case. In such case, the number of backups available is reduced. In particular, when data is backed up in a storage medium such as a CD-R, which is a medium of such type that data which has been once recorded thereinto cannot be deleted, the above-described problem becomes more noticeable because a recordable capacity of a storage medium of such type is limited.

### SUMMARY

An advantage of some aspects of the invention is to provide a backup device and a control device for backup which efficiently record backup data in a medium.

The backup device and the control device for backup according to aspects of the invention employ following means in order to obtain the above advantage.

A backup device according to an aspect of the invention is a backup device which backs up data in a predetermined medium. The backup device includes a first data acquisition unit that acquires backup data, a second data acquisition unit that acquires recorded data which has been already recorded in the predetermined medium, and a backup processing unit that judges whether the acquired backup data matches with the acquired recorded data, records the backup data and reference data for referring to the backup data in the predetermined medium when the backup processing unit judges that the backup data does not match with the recorded data, and records reference data of which reference destination is set to the recorded data which matches with the backup data in the predetermined medium in place of recording the backup data when the backup processing unit judges that the backup data matches with the recorded data.

With the backup device according to the aspect of the invention, it is judged whether backup data matches with recorded data. When it is judged that the backup data does not match with the recorded data, the backup data and reference data for referring to the backup data are recorded in a predetermined medium. On the other hand, when it is judged that the backup data matches with the recorded data, reference data of which reference destination is set to the recorded data which matches with the backup data is recorded in the predetermined medium in place of recording the backup data. Accordingly, overlapped pieces of data are not recorded even when backup of data is repeatedly executed. Therefore, capacity of the predetermined medium can be efficiently utilized.

In the backup device according to the aspect of the invention, it is preferable that when the backup processing unit judges that a backup file as the backup data does not match with a recorded file as the recorded data, the backup processing unit record an entity of the backup file and a file entry for referring to the entity of the backup file in the predetermined medium, and when the backup processing unit judges that the backup file matches with the recorded file, the backup processing unit record a file entry in the predetermined medium in such a manner that the entity of the recorded file which matches with the backup file is a reference destination.

Further, in the backup device according to the aspect of the invention, it is preferable that the predetermined medium be a medium of such type that data which has been once recorded into the medium cannot be deleted. With this, an effect of the aspect of the invention that data can be efficiently recorded in the predetermined medium can be more noticeable. It is to be noted that the “predetermined medium” includes disk media such as a CD-R, a DVD-R, or the like.

A control device for backup according to another aspect of the invention is connected to a writing device which writes data in a predetermined medium and controls the writing device. The control device for backup includes a first data acquisition unit that acquires backup data, a second data acquisition unit that acquires recorded data which has been already recorded in the predetermined medium, and a controller that judges whether the acquired backup data matches with the acquired recorded data, controls the writing device so as to write the backup data and reference data for referring to the backup data in the predetermined medium when the controller judges that the backup data does not match with the recorded data, and controls the writing device so as to write reference data of which reference destination is set to the recorded data which matches with the backup data in the predetermined medium in place of recording the backup data when the controller judges that the backup data matches with the recorded data.

With the control device for backup according to the aspect of the invention, it is judged whether backup data matches with recorded data. When it is judged that the backup data does not match with the recorded data, the backup data and reference data for referring to the backup data are recorded in the predetermined medium. On the other hand, when it is judged that the backup data matches with the recorded data, reference data of which reference destination is set to the recorded data which matches with the backup data is recorded in the predetermined medium in place of recording the backup data. Accordingly, overlapped pieces of data are not recorded even when backup of data is repeatedly executed. Therefore, capacity of the predetermined medium can be efficiently utilized.

Further, the aspect of the invention can be applied to a backup method as a program that operates a backup device or a control device for backup, and applied to a computer as a program storage medium.

### BRIEF DESCRIPTION OF THE DRAWINGS

The invention will be described with reference to the accompanying drawings, wherein like numbers reference like elements.

FIG. 1 is a view illustrating a configuration of a multifunctional printer according to an embodiment.

FIG. 2 is a block diagram illustrating the multifunctional printer according to the embodiment.

FIG. 3 is a flowchart illustrating an example of a backup processing.

FIG. 4 is a descriptive diagram illustrating a configuration example of a directory entry.

FIG. 5 is a descriptive diagram illustrating an example of a backup file to be recorded in a CD-R disk.

FIG. 6 is a descriptive diagram illustrating a directory configuration of data in FIG. 5.

### DESCRIPTION OF EXEMPLARY EMBODIMENTS

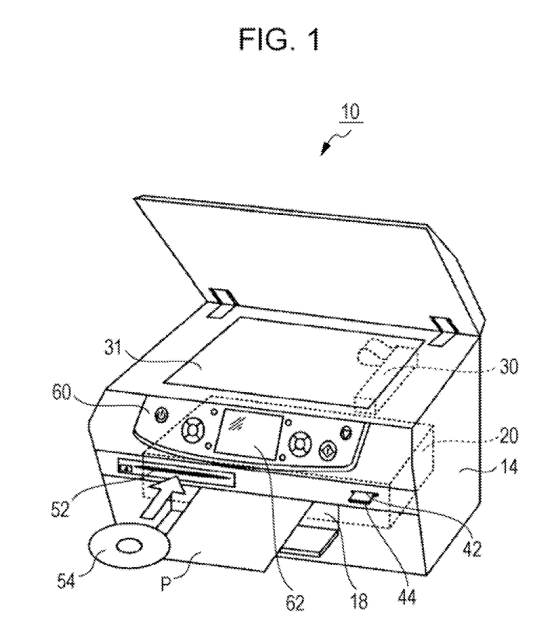

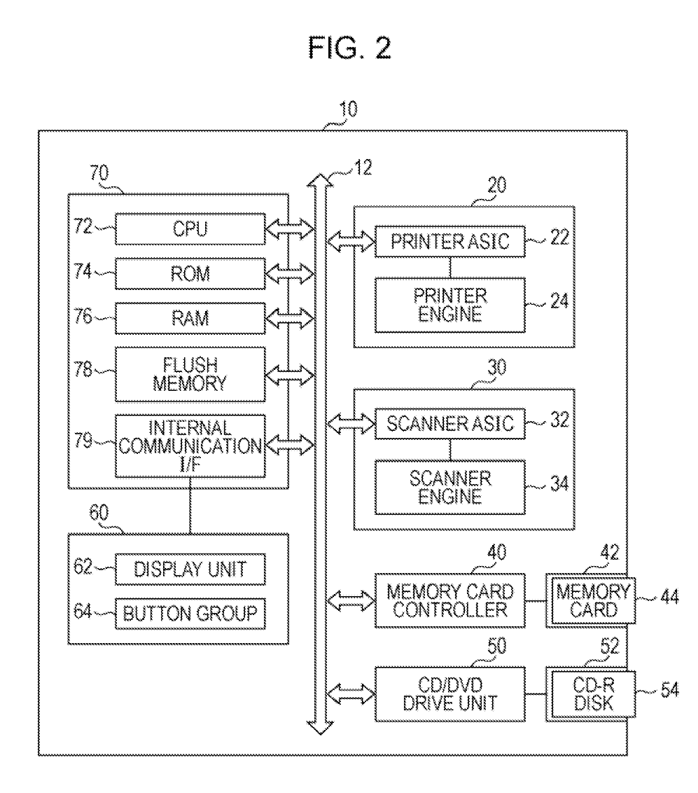

Next an embodiment of the invention will be described with reference to the drawings. FIG. 1 is a view schematically illustrating a configuration of a multifunctional printer 10 according to an embodiment of the invention. FIG. 2 is a block diagram illustrating the multifunctional printer 10 according to the embodiment.

As shown in FIG. 1 and FIG. 2, the multifunctional printer 10 according to the embodiment includes a printer unit 20, a scanner unit 30, a memory card controller 40, a CD/DVD drive unit 50, an operation panel 60 and a main controller 70. The printer unit 20 performs printing onto a sheet fed from a back face of a housing 14 with an ink jet system and discharges the printed sheet from a discharge opening 18 provided on a front face of the housing 14. The scanner unit 30 reads a document placed on a document table 31 fitted into an upper face of the housing 14. The memory card controller 40 controls input and output of data to/from a memory card 44 inserted to a memory card slot 42. The CD/DVD drive unit 50 inputs and outputs data to/from a disk-form storage medium (hereinafter, referred to as CD-R disk 54) such as a CD-R, a DVD-R, or a CD-RW inserted to a disk slot 52. The operation panel 50 displays various types of information on a display unit 52 and inputs a direction from a user through an operation with a button group 64. The main controller 70 controls the entire apparatus. The multifunctional printer 10 is configured such that the printer unit 20, the scanner unit 30, the memory card controller 40, the CD/DVD drive unit 50, and the main controller 70 can exchange various types of control signals and data therebetween via a bus 12.

The printer unit 20 includes a printer ASIC 22 and a printer engine 24. The printer ASIC 22 is an integrated circuit for controlling the printer engine 24. When the printer ASIC 22 receives a print instruction from the main controller 70, the printer ASIC 22 controls the printer engine 24 so as to print onto a sheet based on an image file as a target of the print instruction. The printer engine 24 is configured as a well-known ink jet color printer mechanism in which printing is performed by discharging ink onto a sheet from a printing head. Note that the ASIC stands for Application Specific Integrated Circuit.

The scanner unit 30 includes a scanner ASIC 32 and a scanner engine 34. The scanner ASIC 32 is an integrated circuit for controlling the scanner engine 34. When the scanner ASIC 32 receives a scan instruction from the main controller 70, the scanner. ASIC 32 controls the scanner engine 34 so as to read a document placed on the document table 31 as image data. Further, the scanner engine 34 is configured as a well-known image scanner. The scanner engine 34 includes a well-known color image sensor which separates reflected light after emitting therefrom toward a document into each color of red (R), green (G), and blue (B) so as to generate scan data.

The memory card controller 40 inputs and outputs data to/from the memory card 44 inserted to the memory card slot 42. When the memory card 44 is connected to the memory card slot 42, the memory card controller 40 reads out a file stored in the memory card 44 and transmits the read-out file to the main controller 70 or inputs an instruction from the main controller 70 and writes data into the memory card 44 based on the instruction.

The CD/DVD drive unit 50 inputs and outputs data to/from the CD-R disk 54 inserted to the disk slot 52 which is opened to the front face side of the multifunctional printer 10. When the CD-R disk 54 is inserted to the disk slot 52, the CD/DVD drive unit 50 inputs an instruction from the main controller 70 and writes data into the CD-R disk 54 based on the instruction, or reads out data from the CD-R disk 54 and transmits the read-out data to the main controller 70. In the embodiment, the CD/DVD drive unit 50 writes data into the CD-R disk 54 or reads out data from the CD-R disk 54 based on a file system of ISO 9660. However, the file system is not limited to the file system of ISO 9660 and the CD/DVD drive unit 50 may write data into the CD-R disk 54 or read out data from the CD-R disk 54 based on other file systems.

The operation panel 60 includes a display unit 62 and a button group 64. The display unit 62 is a liquid crystal display. Various types of operation screens on which menu selections or settings are performed are displayed on the display unit 52. The button group 64 includes a power button, a start button, a back button, a mode selection button and the Like. The power button is a button for turning on/off the power source. The start button is a button for executing processings such as printing, or the like. The back button is a button for cancelling a selected processing or making a screen back to a previous screen. The mode selection button is a button for selecting various types of modes. A direction by a user can be input to the main controller 70 through an internal communication interface 79 by the button group 64. Note that the modes which can be selected by the mode selection button include a copy mode, a memory card print mode, a memory card scan mode, a backup mode, and the like. In the copy mode, a document set on the document table 31 is scanned to be copied. In the memory card print mode, printing is performed by using an image stored in the memory card 44. In the memory card scan mode, a document is scanned to be converted into data and the data is stored in the memory card 44. In the backup mode, data stored in the memory card 44 is read out and the read-out data is written into the CD-R disk 54 so as to be stored while being accumulated in a buffer of a RAM 76.

The main controller 70 is configured as a micro processor with a CPU 72 as its center. The main controller 70 includes a ROM 74, the RAM 76, a flush memory 78, and the internal communication interface 79. The ROM 74 stores various types of processing programs, data, tables, and the like. The RAM 76 temporarily stores various types of data such as scan data, print data and data read-out from the memory card 44. The flush memory 78 is an electrically rewritable memory and can hold data even when the power source is turned off. The internal communication interface 79 can communicate with the operation panel 60. The ROM 74, the RAM 76, the flush memory 73, and the internal communication interface 79 are connected so as to exchange signals therebetween via the bus 12. The main controller 70 inputs various types of operation signals and various types of detection signals from the printer unit 20, the scanner unit 30, the memory card controller 40, and the CD/DVD drive unit 50. Further, the main controller 70 inputs operation signals generated in response to operations with the button group 64 of the operation panel 60. In addition, the main controller 70 outputs an instruction to the printer unit 20 to print image data onto a sheet and outputs an instruction to the memory card controller 40 to read out an image file from the memory card 44 and output the read-out image file to the main controller 70. Further, the main controller 70 outputs an instruction to the CD/DVD drive unit 50 to read out data from the memory card 44 and write the read-out data into the CD-R disk 54 while temporarily accumulating the data in a buffer of the RAM 76, or outputs an instruction to the operation panel 60 to control the display unit 62.

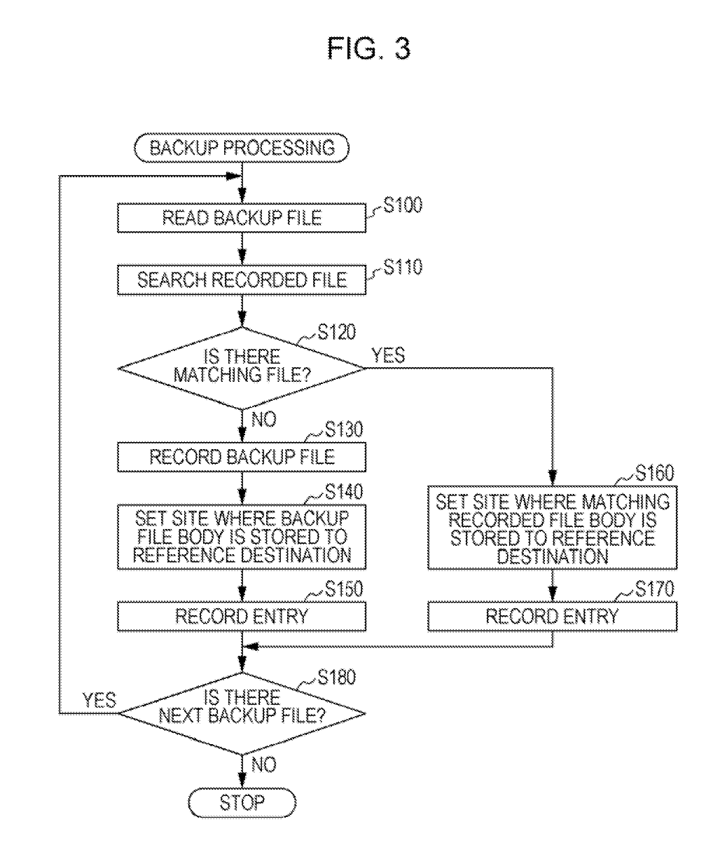

Next, operations of the multifunctional printer 10 according to the embodiment configured as described above, in particular, an operation when an image file stored in the memory card 44 is backed up in the CD-R disk 54 will be described. FIG. 3 is a flowchart illustrating an example of a backup processing routine executed by the CPU 72 of the multifunctional printer 10. The backup processing routine is executed when the memory card 44 is inserted to the memory card slot 42 and the backup mode is selected by an operation with the button group 64. It is to be noted that data which enables a file entity to be referenced by relating pieces of information for identifying files to cluster numbers, pointers or the like in the file system is referred to as a directory entry, hereinafter. The pieces of information include a file name, and the like. Further, the cluster numbers the pointers or the like indicate locations of the file entities.

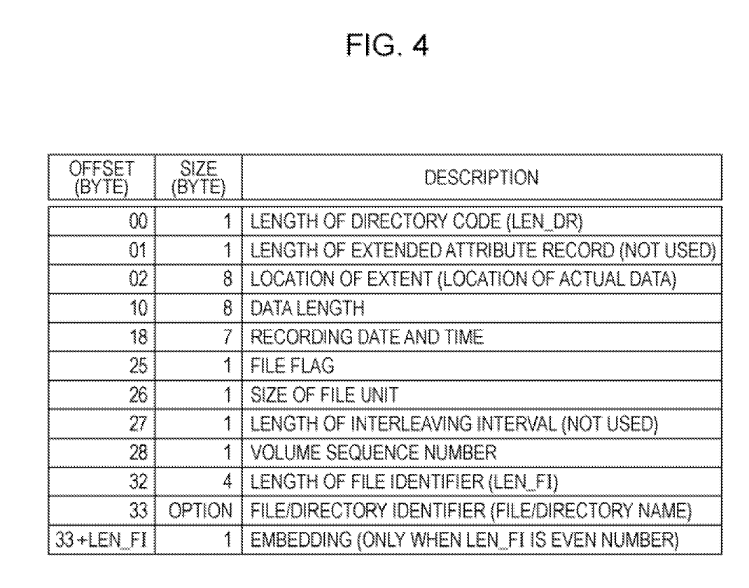

When the backup processing routine is executed, First, the CPU 72 reads an image file to be backed up (hereinafter, referred to as backup file) from the memory card 44 (step S100). Further, the CPU 72 reads data from the CD-R disk 54 as a backup destination and searches files which have been already recorded in the CD-R disk 54 (hereinafter, referred to as recorded file) (step S110). Then, the CPU 72 judges whether there is a file which matches with the backup file in the recorded files stored in the CD-R disk 54 (step S120). Note that when data is read from the CD-R disk 54, directory entries of the CD-R disk 54 may be read or all the data stored in the CD-R disk 54 may be read. With the former method, although data can be read faster than the latter method, data of which information is not included in the directory entry but which is present in the file entity cannot be recognized. After the step S120, when there is no file which matches with the backup file in the recorded files, the entity of the backup file is recorded in the CD-R disk 54 (step S130). At the same time, a directory entry in which a cluster number at a site where the entity of the backup file is stored is set to a reference destination is prepared (step S140), and the directory entry is recorded (step S150). On the other hand, when there is a file which matches with the backup file in the recorded files, the backup file is not recorded and a directory entry in which a cluster number at a site where the recorded file which matches with the backup file is stored is set to a reference destination is prepared (step S160), and the directory entry is recorded (step S170). FIG. 4 illustrates a configuration example of a directory entry. As shown in FIG. 4, as the directory entry to be recorded, length of a directory code (LEN_DR), length of an extended attribute record (not used), location of extent (location of actual data), data length, recording date and time, file flag, size of a file unit, length of interleaving interval (not used), volume sequence number, length of file identifier (LEN_FI), a file/directory identifier (file/directory name), embedding, and the like are included. Then, the CPU 72 judges whether backup file(s) to be backed up is(are) left (step S180). When back up file(s) to be processed is(are) left, the process returns to step S100 and processings in steps S100 through S170 are repeatedly performed to the backup file(s) left. On the other hand, when no backup file to be processed is left, the routine ends.

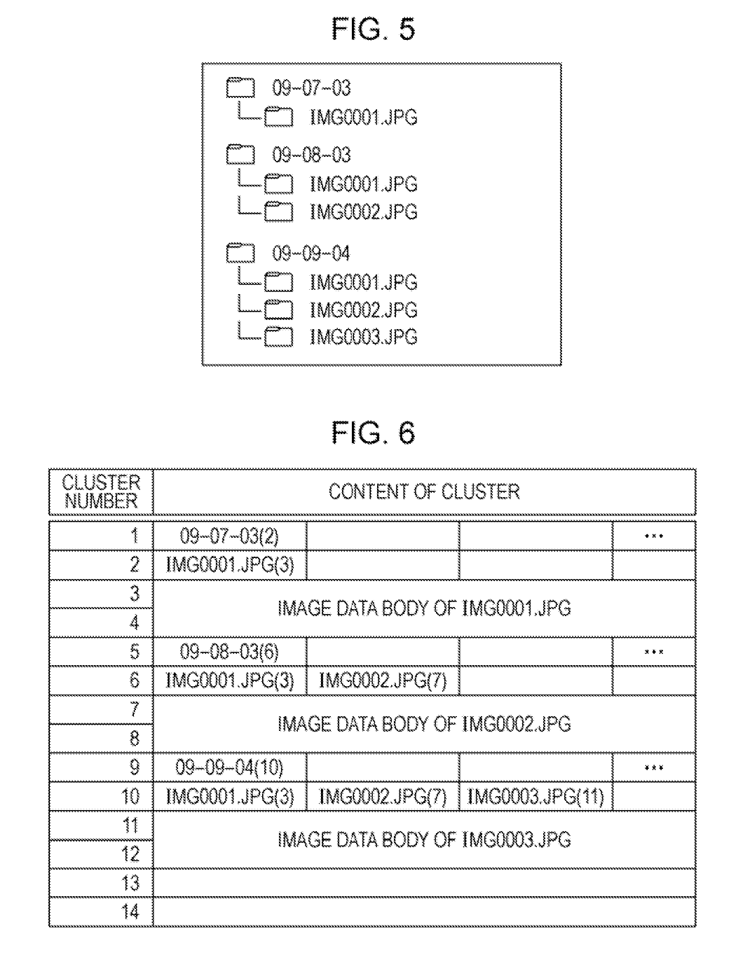

FIG. 5 illustrates an example of a backup file to be recorded in the CD-R disk 54. FIG. 6 illustrates a directory configuration of data in FIG. 5. In FIG. 5 and FIG. 6, “09-07-03(2),” “09-08-03(6)” and “09-09-04(10)” indicate directories each of which directory name is set to a backup date. Further, “IMG0001.JPG(3),” “IMG0002.JPG(7)” and “IMG0003.JPG(11)” are file entries and file bodies thereof are separately recorded. Note that each of numerals in parentheses indicates a cluster number of a reference destination. As shown in FIG. 5 and FIG. 6, the directory “09-07-03(2)” indicates that a file entry “IMG0001.JPG(3)” is present in a region of cluster number 2 and a file body for the file entry “IMG0001.JPG(3)” is stored in a region of cluster number 3. Further, the directory “09-08-03(6)” indicates that the file entry “IMG0001.JPG(3)” and the file entry “IMG0002.JPG(7)” are present in a region of cluster number 6 and a file body for the file entry “IMG0001.JPG(3)” is stored in a region of cluster number 3 and a file body for the file entry “IMG0002.JPG(7)” is stored in a region of cluster number 7. Further, the directory “09-09-04(10)” indicates that a file entry “IMG0001.JPG(3),” a file entry “IMG0002.JPG(7)” and a file entry “IMG0003.JPG(11)” are present in a region of cluster number 10 and a file body for the file entry “IMG0001.JPG(3)” is stored in the region of cluster number 3, a file body for the file entry “IMG0002.JPG(7)” is stored in a region of cluster number 7, and a file body for the file entry “IMG0003.JPG(11)” is stored in a region of cluster number 11. A case where the memory card 44 which stores “IMG0001.JPG” and “IMG0002.JPG” is backed up on Aug. 3, 2009 and a backup file is newly recorded in a directory “09-08-03” newly created is considered. At this time, the memory card 44 is hacked up in a state where the file of “IMG0001.JPG” has been previously recorded (backed up) in a directory “09-07-03” by backup of the memory card 44 which stores “IMG0001.JPG” on Jul. 3, 2009. In this case, the file of which file entry is “IMG0002.JPG” is not present in the CD-R disk 54 as a backup destination. Therefore, a file body therefor is newly recorded (recorded in a region of cluster number 7) and the cluster number 7 as a reference destination of the file body is also recorded. On the other hand, the file of which file entry is “IMG0001.JPG” has been already recorded in the directory “09-07-03.” Therefore, only a cluster number 3 as a reference destination of the recorded file of “IMG0001.JPG” is recorded in the directory entry but a file body therefor is not recorded. Next, a case where the memory card 44 which stores “IMG0001.JPG,” “IMG0002.JPG” and “IMG0003.JPG” is backed up on Sep. 4, 2009 and a backup file is newly recorded in a directory “09-09-04” newly created is considered. In this case, the file of which file entry is “IMG0003.JPG” is not present in the CD-R disk 54. Therefore, a file body therefor is newly recorded (recorded in a region of cluster number 11) and the cluster number 11 as a reference destination of the file body is recorded. On the other hand, the file of which file entry is “IMG0001.JPG” and the file of which file entry is “IMG0002.JPG” have been already recorded in the CD-R disk 54. Therefore, only a cluster number 3 as a reference destination of the recorded file of “IMG0001.JPG” is recorded in the directory entry and a cluster number 7 as a reference destination of the recorded file of “IMG0002.JPG” is recorded in the directory entry but the file bodies therefor are not recorded. Thus, when there is the same file as a file to be backed up in the recorded files stored in the CD-R disk 54, a file body is not newly recorded and one file body is shared by setting a reference destination of the backup file to a site where the file body of the same recorded file is stored. With this configuration, the number of files to be recorded can be reduced by the number of overlapped files.

Correspondence relationship between components according to the embodiment and components according to the invention is made clear. The memory card controller 40, the memory card slot 42, and the CPU 72 according to the embodiment correspond to a first data acquisition unit according to the invention. Note that the CPU 72 executes the processing in step S100 in the backup processing routine as shown in FIG. 3. The CD/DVD drive unit 50, the disk slot 52, and the CPU 72 according to the embodiment correspond to a second data acquisition unit according to the invention. Note that the CPU 72 executes the processing in step S110 in the backup processing routine. The CPU 72 which executes the processings in steps S120 through S180 in the backup processing routine corresponds to a backup processing unit according to the invention. The directory entry corresponds to reference data.

With the multifunctional printer 10 according to the above-described embodiment, when a backup file is recorded in the CD-R disk 54, it is judged whether there is a file which matches with the backup file in recorded files. When there is no file which matches with the backup file, the backup file is recorded in the CD-R disk 54 and a reference destination of a file body of the backup file is recorded in the directory entry. On the other hand, when there is a file which matches with the backup file, the backup file is not recorded and the reference destination in which a file body of the recorded file which matches with the backup file is stored is recorded in the directory entry. This makes it possible to prevent overlapped files from being recorded in the CD-R disk 54. As a result, backup data can be efficiently recorded in the CD-R disk 54. Further, when the backup file is recorded in the CD-R disk 54, it is judged whether there is a file which matches with the backup file in the recorded files (S100 through S120). When there is a file which matches with the backup file, the reference destination in which a file body of the recorded file which matches with the backup file is stored can be recorded in the directory entry (S160, S170).

In the embodiment, the invention is applied to a case where an image file is backed up. However, data to be backed up is not limited to the image file and may be any files such as a document file, a sound file and a moving image file. Further, the directory entry is not limited to the above-described one and may have other configurations.

In the embodiment, the invention is applied to a case where a file is backed up in the CD-R disk 54. However, a recording medium is not limited to the CD-R disk 54 and may be any media such as a DVD-R disk, or the like.

In the embodiment, the invention is applied to the multifunctional printer 10. However, the invention may be applied to a printer without the scanner unit 30. Further, the invention may be applied to any devices other than the printer as long as the devices can write backup data into a storage medium. In addition, the invention may be realized in form of a control device which controls writing of backup data into an external device such as an external CD/DVD drive unit.

The invention is not limited to the above embodiment and it is needless to say that the invention can be executed in various modes as long as the modes are within a technical range of the invention.

What is claimed is:

1. A backup device which backs up data in a predetermined medium comprising:
a first data acquisition element that acquires backup data;
a second data acquisition element that acquires recorded data which has been already recorded in the predetermined medium; and
a backup processing element that judges whether the backup data matches with the recorded data, records the backup data and reference data for referring to the backup data in the predetermined medium when the backup processing element judges that the backup data does not match with the recorded data, and records reference data of which reference destination is set to the recorded data which matches with the backup data in the predetermined medium when the backup processing element judges that the backup data matches with the recorded data.

2. The backup device according to claim 1,
wherein when the backup processing element judges that a backup file as the backup data does not match with a recorded file as the recorded data, the backup processing element records an entity of the backup file and a file entry for referring to the entity of the backup file in the predetermined medium, and when the backup processing element judges that the backup file matches with the recorded file, the backup processing element records a file entry in the predetermined medium in such a manner that an entity of the recorded file which matches with the backup file is a reference destination.

3. The backup device according to claim 1,
wherein the backup processing element judges whether there is data which matches with the backup data in pieces of data which have been already recorded in the predetermined medium, and when there is data which matches with the backup data, the backup processing element records reference data of which reference destination is recorded data which matches with the backup data when data which has been already recorded in the predetermined medium and matches with the backup data is set to the recorded data.

4. The backup device according to claim 1,
wherein the predetermined medium is a medium of such type that data which has been once recorded into the medium cannot be deleted.

5. A control device for backup which is connected to a writing device which writes data in a predetermined medium and controls the writing device, comprising:
a first data acquisition element that acquires backup data;
a second data acquisition element that acquires recorded data which has been already recorded in the predetermined medium; and
a controller that judges whether the backup data matches with the recorded data, controls the writing device so as to write the backup data and reference data for referring to the backup data in the predetermined medium when the controller judges that the backup data does not match with the recorded data, and controls the writing device so as to write reference data of which reference destination is set to the recorded data which matches with the backup data in the predetermined medium when the controller judges that the backup data matches with the recorded data.

6. A backup method which backs up data in a predetermined medium, comprising:
acquiring backup data;
acquiring recorded data which has been already recorded in the predetermined medium;
judging whether the backup data matches with the recorded data;
recording the backup data and reference data for referring to the backup data in the predetermined medium when it is judged that the backup data does not match with the recorded data; and
recording reference data of which reference destination is set to the recorded data which matches with the backup data in the predetermined medium when it is judged that the backup data matches with the recorded data.
